(19) United States
(12) Patent Application Publication
(10) Pub. No.: US 2008/0134583 A1
(43) Pub. Date: Jun. 12, 2008

(54) Non-hanging sliding door system

(76) Inventor: Doron Polus, Agoura Hills, CA (US)

Correspondence Address: PILLSBURY WINTHROP SHAW PITTMAN LLP, P.O BOX 10500, McLean, VA, 22102, US

(21) Appl. No.: 11/634,605

(22) Filed: Dec. 6, 2006

(51) Int. Cl. E05D 13/00

(52) U.S. Cl. 49/426; 49/425

(57) ABSTRACT

A non-hanging sliding door system includes a sliding door having an upper roller assembly disposed atop a portion of the door's frame, a channeled upper track configured to receive rollers of the upper roller assembly, a lower wheel assembly disposed at a bottom portion of the frame, and a guiding roller assembly. The lower wheel assembly includes a vertical spine having a transverse shaft, and a pair of sliding wheels that are rotatably coupled to the transverse shaft and are in direct contact with the ground without the need for a lower track. The guiding roller assembly includes one or more rollers that roll in frictional contact with the walls of a channel defined in the underside of the frame. The guiding roller assembly may be coupled either directly to the ground/floor below the door, or to a wall parallel to the door using a mounting bracket.

### RELATED APPLICATION DATA

This application is related to application Ser. No. 11/521,237, filed Sep. 14, 2006, the entire contents of which are incorporated herein by reference.

### FIELD OF INVENTION

This invention relates generally to non-hanging sliding door systems and, more particularly, to non-hanging sliding doors, windows, mirrors, etc. that include upper rollers, lower sliding wheels, and guiding rollers that together provide a smooth and quiet glide without the use of a lower track.

### BACKGROUND OF THE INVENTION

Every sliding door usually has an upper track and a lower track. In some applications, such as, e.g., the so-called “barn doors”, the door is actually designed to hang from the upper track, such that the upper track carries the majority, if not all, of the door's weight. With such doors, a lower track is normally used to serve as a guide and to keep the door from swinging from side to side.

In certain hanging-type sliding door systems, it is sometimes possible to eliminate the lower track. Nevertheless, regardless of whether a lower track is used, upper tracks of hanging doors are generally known to be problematic because particles accumulate in the track, making it more difficult for the door to slide, and eventually causing the door to become stuck. Once the door has become stuck, the door must be removed in order to clean the track.

In other applications, the majority of the weight of the door is carried by the lower track. Here, the upper track is generally designed in such a way as to guide the door so as to keep it in line and in place. As a result, the upper part of the door is usually looser, and typically creates undesirable noises caused by the friction between the upper part of the door and portions of the upper track.

Thus, in a majority of existing systems, a lower track is usually necessary, either to carry the weight of the door, or to provide a guide when the door's weight is carried by the upper track. Quite often, however, such lower tracks are not only unsightly, but also a health hazard. For example, in applications where a sliding door is used as a room divider, or a pocket door, opening of the door exposes a lower track that is generally attached to the ground. Thus, individuals walking across the room are in constant danger of tripping over the lower track. In addition, even with low-profile lower tracks, it is still important to ensure that the door always remains in its track. In this regard, disengagement of a sliding door (or window, mirror, etc.) from its track is problematic for at least two reasons. First, the door, or portions thereof, might fall and break, thereby requiring costly repair or replacement. Second, and more importantly, a disengaged sliding door presents a significant health hazard not only to the individual operating the door, but also to any bystanders in the vicinity of the door.

Moreover, existing sliding doors provide little or no flexibility based on their functionality. However, it may be desirable to customize a sliding door based on the door's intended function. For example, if the door is intended to function as a room divider, it may be desirable for the panel to be multi-faceted, e.g., have multiple horizontal or vertical panel designs.

However, the only way to achieve such function-based designs with existing systems is to manufacture the door with multiple panels cut to produce the desired shapes and angles. Thus, in order for a glass door to appear as if it has three horizontal sections, for example, the door would have to be manufactured with three pieces of glass fitted within a frame that includes four horizontal frame members. This practice, however, requires that each and every sliding door be custom-made, thereby making it labor- and cost-intensive. In addition, once a door has been custom-made, the only way for a different design to be achieved—e.g., four horizontal sections instead of three—would be for another door to be custom made with the new specifications, thereby rendering the old door useless.

What is needed, therefore, is a sliding door system that allows the door to slide back and forth smoothly without any obstacles, interruptions, or undesirable noises, eliminates the need for a lower track while, at the same time, doing away with a hanging-type upper track, and allows for repeated customization without the requirement of manufacturing a new, custom-made door each time.

### BRIEF DESCRIPTION OF THE DRAWINGS

FIG. 1 shows a frontal view of a sliding door system in accordance with an embodiment of the invention;

FIG. 2 shows an end view of an upper section of a sliding door in accordance with an embodiment of the invention;

FIG. 3 shows an upper roller assembly according to an embodiment of the invention;

FIG. 4 shows an end view of a lower section of a sliding door in accordance with an embodiment of the invention;

FIG. 5 shows a lower wheel assembly according to an embodiment of the invention;

FIG. 6 shows an exploded view of the lower wheel assembly shown in FIG. 5;

FIG. 7 shows a perspective view of the horizontal bottom portion of a door frame in accordance with an embodiment of the invention;

FIG. 8 shows a guiding roller assembly according to an embodiment of the invention;

FIG. 9 shows the guiding roller assembly of FIG. 8 in conjunction with a mounting bracket;

FIG. 10 shows a perspective view of the vertical side portions of a door frame in accordance with an embodiment of the invention;

FIG. 11 shows a perspective view of a vertical structural member of a door frame in accordance with an embodiment of the invention; and

FIG. 12 shows a frontal view of a sliding door employing the vertical structural member of FIG. 11 as a central vertical member.

### DETAILED DESCRIPTION

In light of the above-mentioned need, the instant invention is directed to a sliding door system with an upper, non-hanging type roller assembly, that provides a smooth and quiet glide, a guiding roller assembly to eliminate the need for a lower track, and a means for effecting design flexibility in a time- and cost-efficient manner.

It is noted that, although, throughout the ensuing discussion, reference is made to a sliding “door”, such reference is made by way of illustration, and not limitation. Thus, the instant invention encompasses sliding structures that may be used as doors (e.g., closet doors); room dividers; (wall) pocket doors, where the sliding “door” extends from, and retracts into, a wall cavity; wall sliders, where the sliding “door” slides back and forth from behind the wall; loft enclosures; cubicle enclosures, etc. In addition, the term “door” is used herein generically and without limitation as to the material of which the door's panel is made. Thus, the panel may be made of clear glass, milky glass, frosted glass, mirror, etc., and combinations thereof.

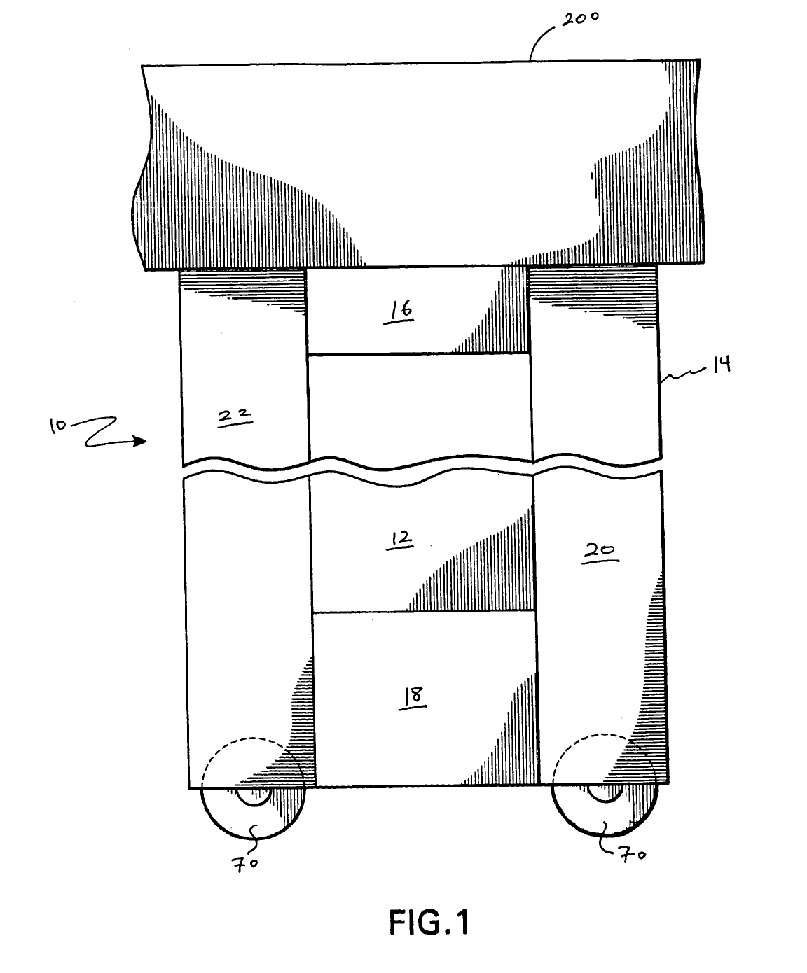

FIG. 1 shows a sliding door assembly, including a door 10, a pair of lower sliding wheel sets 70, and an upper track 200. The door 10 includes a panel 12 encased within a frame 14 which comprises a horizontal top portion (or member) 16, a horizontal bottom portion 18, a first vertical side portion 20, and a second vertical side portion 22. As shown, opposing horizontal members 16 and 18 are vertically spaced apart from one another, and opposing vertical members 20 and 22 are horizontally spaced apart from one another. As shown in FIG. 7, in a preferred embodiment, the lower surface (i.e., the underside) of the horizontal bottom portion 18 defines a longitudinal channel 319 having first and second opposing side walls 321, 323 that extend downwards.

In embodiments of the invention, the members 16, 18, 20, 22 may be made of aluminum. In addition, in embodiments where the panel 12 is made of glass, the glass may be tempered, and have a thickness of at least 4.0 mm, and more preferably, a thickness of at least 5.0 mm.

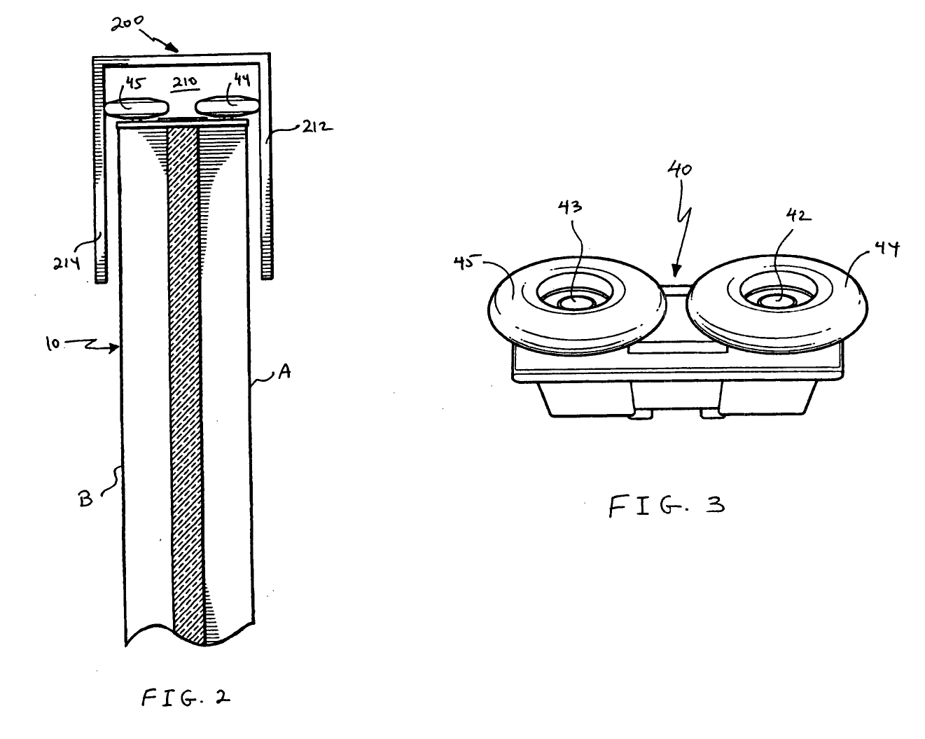

As shown in FIGS. 2 and 3, in a preferred embodiment, the door 10 includes at least one upper roller assembly 40. The upper roller assembly 40 is coupled to an upper part of the frame 14 that is proximate the horizontal top portion 16. Preferably, for each door 10, one upper roller assembly 40 is disposed atop each of the vertical side portions 20, 22.

The upper roller assembly 40 includes first and second rollers 44, 45 that are rotatably mounted on respective first and second vertical shafts 42, 43. With reference to FIG. 2, the first shaft 42 is disposed adjacent the front side A of the frame 14, and the second shaft 44 is disposed adjacent the back side B of the frame 14. In this way, the periphery of the first roller 44 extends beyond the plane of the frame's (and door's) front side A, and the periphery of the second roller 45 extends beyond the plane of the frame's (and door's) back side B.

The above configuration is significant because it allows the door 10 to be stable and slide smoothly without any frictional contact between the upper track 200 and the door 10. Specifically, the upper track 200 defines a channel 210 having first and second opposing side walls 212, 214. As shown in FIG. 2, the first side wall 212 extends downwards over, and parallel to, the front side A of the frame's horizontal top portion, and the second side wall 214 extends downwards over, and parallel to, the back side B of the frame's horizontal top portion. As noted above, the combined span of the rollers 44, 45 extends beyond the width of the frame 14. As such, in operation, the first roller 44 rotates in frictional contact with an inner surface of the first side wall 212, and the second roller 45 rotates in frictional contact with an inner surface of the second side wall 214, thereby eliminating any frictional contact between the frame 14 and the side walls 212, 214.

It is noted that, in a preferred embodiment, the combined span of the rollers 44, 45 is slightly larger than the horizontal distance between the respective inner surfaces of the side walls 212, 214, and rollers 44, 45 are made of flexible rubber, so as to provide for a snug fit between the rollers 44, 45 and the side walls 212, 214. In addition, in embodiments of the invention, one or both of the side walls 212, 214 may extend far enough downwards to completely cover (the front side A, and/or the back side B, respectively, of) the horizontal top portion 16 of the frame 14.

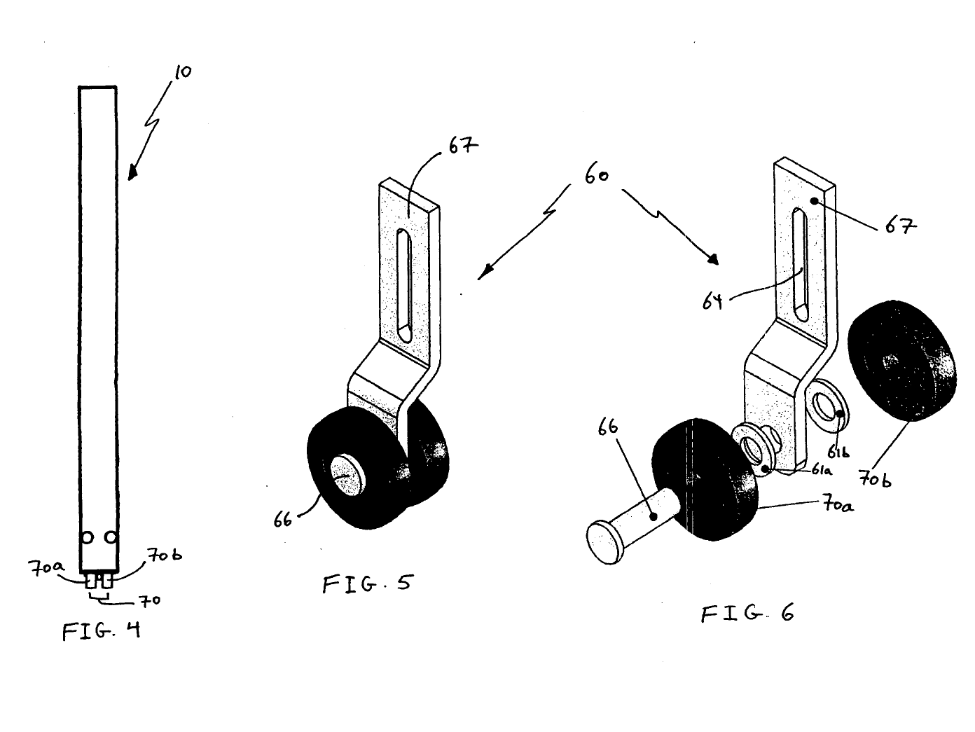

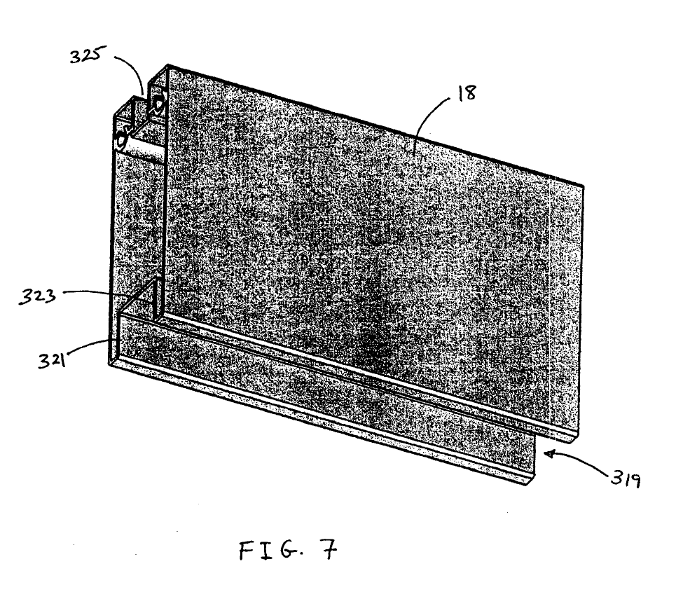

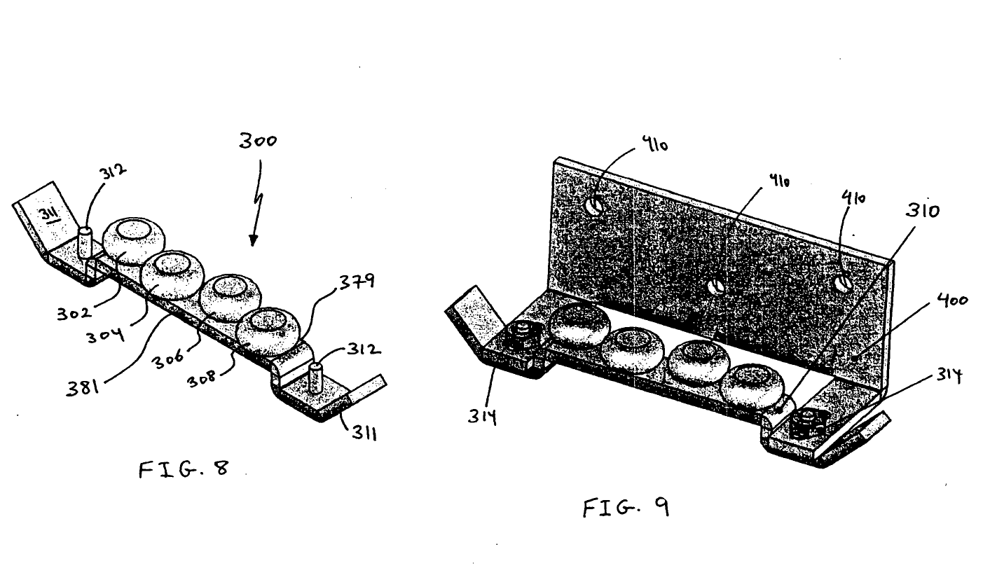

As shown in FIGS. 4-6, in a preferred embodiment, the door 10 includes at least one lower wheel assembly 60. The lower wheel assembly 60 is coupled to a lower part of the frame 14 that is proximate the horizontal bottom portion 18. Preferably, for each door 10, one lower wheel assembly is disposed at the bottom of each of the vertical side portions 20, 22.

In a preferred embodiment, the lower wheel assembly 60 includes a vertical spine 67 which, in turn, has a vertical slot 64 through its central portion. The vertical spine 67 also includes a transverse shaft 66 that is coupled towards a bottom portion of the spine. Lower wheels (e.g., non-marking sliding wheels) 70a, 70b are rotatably coupled to the transverse shaft 66 on respective opposing sides of the vertical spine 67 to form a wheel set 70. Preferably, a washer 61a, 61b is disposed between each of the lower wheels 70a, 70b and the vertical spine 67.

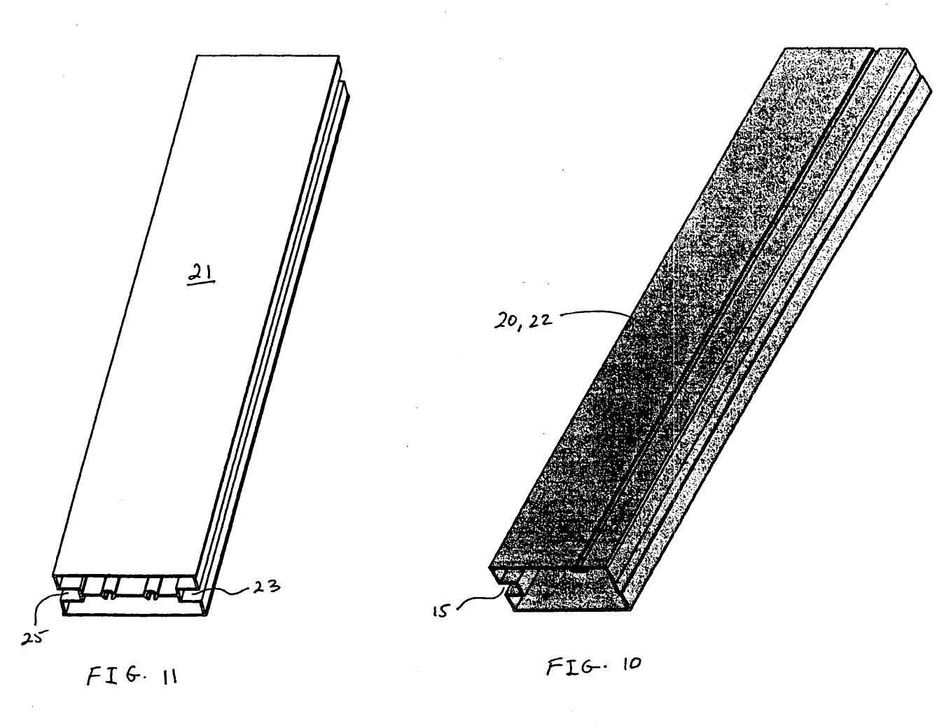

The transverse shaft 66 is perpendicular to the plane of the panel 12, which, in turn, is generally received within a groove 15 that is defined in each of the first and second vertical side portions 20, 22 (see FIG. 10) and a groove 325 defined in the upper surface of the horizontal bottom portion 18 (see FIG. 7). It is noted that a groove similar to groove 325 is defined in the lower surface of the horizontal top portion 16 for receiving the upper edge, or side, of the panel 12.

In practice, the spine 67 connects to a mounting bracket (not shown) by attachment means, such as, for example, screws or bolts, through the vertical slot 64. The mounting bracket, in turn, couples to the vertical side portion 20, 22 using screws or similar attachment means. The height of the vertical spine 67 (and, therefore, the height of the door 10) can then be adjusted by moving the spine 67 up or down, and then fastening to the mounting bracket at the desired location. By way of example, the lower wheel assembly 60 may be coupled to the frame 14 in the manner disclosed in co-pending application Ser. No. 11/521,237, the entire contents of which are incorporated herein by reference. Regardless of the specific coupling mechanism that is used, however, the lower wheel assembly 60 is coupled to the frame 14 in such a way as to allow the wheels 70a and 70b of each lower wheel assembly 60 to be in direct contact with the floor below the door 10, with no intervening lower track.

In embodiments of the invention, the sliding door system includes a guiding roller assembly having one or more guiding rollers. In a specific example shown in FIGS. 8 and 9, the guiding roller assembly 300 includes four such rollers 302, 304, 306, 308. As shown, the guiding roller assembly 300 includes a horizontal spine 310 on which the guiding rollers are rotatably mounted in a staggered configuration. Thus, in the example of FIG. 8, the guiding rollers are mounted onto the horizontal spine 310 such that the respective centers (i.e., the respective axes of rotation) of rollers 302, 306 lie on one side of the horizontal spines' longitudinal axis, and the respective centers of rollers 304, 308 lie on the opposite side of the horizontal spine's longitudinal axis. In this way, the respective peripheries of the rollers 302, 306 extend beyond the plane of a first side 379 of the horizontal spine 310, and the respective peripheries of the rollers 304, 308 extend beyond the plane of the opposite side 381 of the horizontal spine 310.

The above configuration, whereby respective centers of successive rollers lie on opposite sides of the horizontal spine's longitudinal center line, is significant because it allows the door 10 to be stable and slide smoothly while preventing lateral swinging of the door 10. Specifically, the guiding rollers 302-308 are received in the longitudinal channel 319 of the frame's horizontal bottom portion 18 (see FIG. 7). Thus, in operation, rollers 302, 306 rotate in frictional contact with an inner surface of the first wall 321, and the rollers 304, 308 rotate in frictional contact with an inner surface of the second wall 323, of the longitudinal channel 319, thereby providing lateral support for the frame 14 (and, therefore, for the door 10).

It is noted, as mentioned previously, that the illustrative example discussed herein employs four guiding rollers. Embodiments of the invention may, however, employ fewer, or more, than four such rollers. In addition, in a preferred embodiment, the combined span of any two successive rollers, e.g., roller 302 and roller 304, may be slightly larger than the horizontal distance between the respective inner surfaces of the side walls 321, 323, and the rollers may be made of flexible rubber, so as to provide for a snug fit between the guiding rollers and the side walls.

In embodiments of the invention, the horizontal spine 310 may have angled flanges 311 at its longitudinal ends. In operation, the extent to which the door 10 can move back and forth is defined by the contact between each flange 311 and the corresponding (longitudinal) end of the channel 319, which may be defined, respectively, by the bottom part of each of the vertical side portions 20, 22.

In addition, the horizontal spine 310 includes attachment means 312 which allow the guiding roller assembly 300 to be used in at least two different ways. More specifically, the ground (or floor) directly below the bottom of the door 10 may be non-covered, or it may be covered by any number of materials, such as, e.g., carpet, tile, laminate, marble, hard wood, slate, etc. Depending on the latter, it may/may not be possible, or desirable, to drill (or otherwise perform any manner of work directly on) the floor.

Thus, in one application, where it may be possible and/or desirable to drill the floor, the roller assembly 300 may be attached directly to the floor by using attachment means (e.g., bolts, screws, etc.) 312. When, on the other hand, it is not possible, or desirable, to drill the floor, the horizontal spine 310 may be coupled to a mounting bracket 400 by using the attachment means 312 and hex nuts 314. Of course, when attachment means other than bolts are used, the holding means 314 will correspond to the specific type of attachment means used, rather than the hex nuts shown in FIG. 9. In addition, although FIG. 9 shows a generally L-shaped mounting bracket 400, brackets having other configurations may also be used in conjunction with the principles of the present invention.

When the guiding roller assembly 300 is not coupled directly to the floor, the mounting bracket 400 is coupled to a wall parallel and adjacent to the sliding door 10 through the attachment holes 410 in such a way as to place the horizontal spine 310 directly below the horizontal bottom portion 18, and the guiding rollers inside the channel 319. In this way, the need to drill the floor is eliminated. In either embodiment, however, the guiding roller assembly 300 is generally disposed adjacent one of the bottom corners of the door 10 such that, when the door is closed (e.g., when a room divider is fully drawn to divide the space), the free end of the door, i.e., the end that is normally used to pull the door, is farthest from the guiding roller assembly 300.

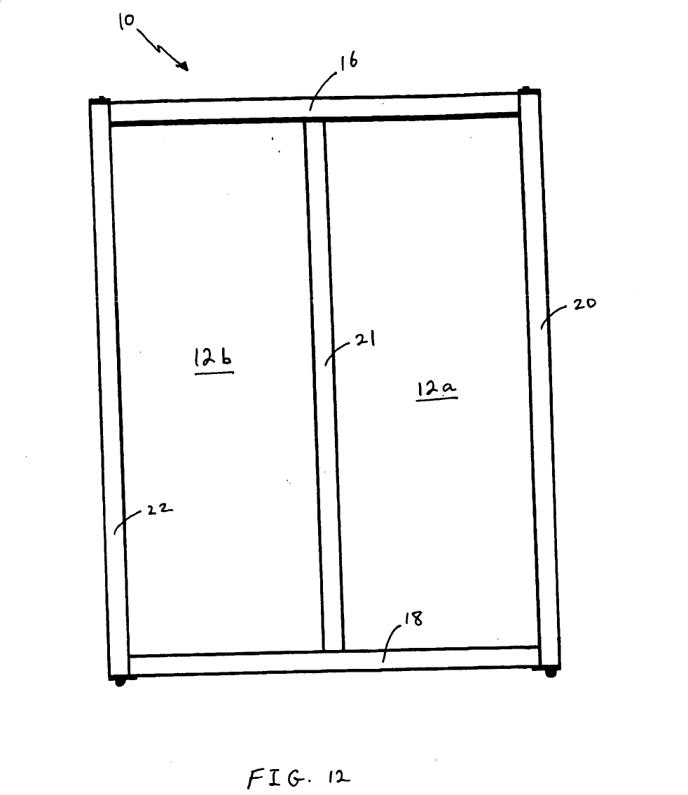

FIGS. 11 and 12 show another embodiment of the invention in which a vertical member 21 is used to provide a sliding door with two or more panels. More specifically, the vertical member 21 has opposing longitudinal grooves 23, 25. Thus, the frame 14 may include member 21 in parallel with first and second vertical side portions 20, 22. In this configuration, a first panel 12a is encased between (the groove 15 of) the first vertical side portion 20 and (the groove 23 of) the vertical member 21, and a second panel 12b is encased between (the groove 15 of) the second vertical side portion 22 and (the groove 25 of) the vertical member 21. It is noted that, while FIG. 12 shows a single vertical member 21 that is centrally located, the number and placement of the vertical member(s) 21 are not so limited. Thus, for example, a single vertical member may be disposed to the left or to the right of center, thereby creating two asymmetric panels. In addition, two or more vertical members 21 may be used, either at regular or irregular (horizontal) intervals.

As noted previously, existing sliding doors allow little to no flexibility in panel design. As shown, for example, in FIGS. 8A-8C of co-pending application Ser. No. 11/521,237, divider strips may be removably attached, e.g., via double-sided tape, to the panel 12 (or the panels 12a and 12b, etc.). Thus, for example, a single, horizontal divider strip may be attached to the panel 12 so as to provide the appearance of two separate (i.e., upper and lower) panels. Similarly, multiple horizontal dividers may be used to provide an appearance of multiple separate panels.

It is noted that, because the dividers can be placed anywhere on the panel, the resulting appearance can be asymmetrical, if such asymmetry is desired. In addition, the dividers may be placed on the panel 12 horizontally, vertically, diagonally, and/or in a combination of orientations. For example, a panel may include a “T” configuration on the bottom, and an inverted “T” configuration on top, etc. Moreover, the dividers may be used in combination with doors that include structural “dividers”, such as doors that include one or more vertical members 21, as discussed above.

While the description above refers to particular embodiments of the present invention, it will be understood that modifications may be made without departing from the spirit thereof. The accompanying claims are therefore intended to cover such modifications as would fall within the true scope and spirit of the present invention.

What is claimed is:

1. A sliding door system comprising:
(a) a sliding door having a panel that is encased within a frame, wherein said frame comprises a horizontal top portion, a horizontal bottom portion, and opposing first and second vertical side portions, said door further including a first upper roller assembly having horizontal rollers and being disposed proximate said top portion of the frame and a first lower wheel assembly disposed proximate said bottom portion of the frame;
(b) an upper track configured to receive said horizontal rollers; and
(c) a guiding roller assembly having a plurality of guiding rollers, said guiding rollers being disposed horizontally so as to have respective vertical axes of rotation and being in contact with an underside of the frame's horizontal bottom portion.

2. The system of claim 1, wherein said upper roller assembly includes first and second rubber rollers rotatably mounted on respective first and second vertical shafts, said first shaft being disposed adjacent a front side of the frame such that the first roller's periphery extends beyond the plane of the frame's front side, and said second shaft being disposed adjacent a back side of the frame such that the second roller's periphery extends beyond the plane of the frame's back side.

3. The system of claim 2, wherein said upper track defines a channel having first and second opposing side walls that respectively extend downwards over, and parallel to, the front and back sides of the frame's horizontal top portion, such that said first roller rotates in frictional contact with said first side wall and said second roller rotates in frictional contact with said second side wall.

4. The system of claim 2, said door further including a second upper roller assembly, wherein the first upper roller assembly is disposed proximate one end of the frame's horizontal top portion and the second upper roller assembly is disposed proximate an opposite end of the frame's horizontal top portion.

5. The system of claim 1, wherein the underside of the frame's horizontal bottom portion includes a longitudinal channel configured to receive said guiding rollers.

6. The system of claim 5, said horizontal bottom portion further including a longitudinal groove on its upper side to receive the panel's bottom side.

7. The system of claim 6, wherein each of the frame's horizontal top portion, first vertical side portion, and second vertical side portion includes a longitudinal groove for receiving respective edges of the panel.

8. The system of claim 1, wherein the guiding roller assembly includes a horizontal spine, said guiding rollers being rotatably mounted on the spine in a staggered configuration such that respective centers of successive rollers are disposed on opposite sides of the spine's longitudinal center line.

9. The system of claim 8, wherein the guiding roller assembly includes first and third guiding rollers that are disposed to the left of the spine's center line and second and fourth guiding rollers that are disposed to the right of the spine's center line, such that each of the first and third guiding rollers' respective periphery extends beyond the plane of the spine's left side and each of the second and fourth guiding rollers' respective periphery extends beyond the plane of the spine's right side.

10. The system of claim 9, wherein the underside of the frame's horizontal bottom portion defines a channel having first and second opposing side walls that extend downwards, and said first and third guiding rollers rotate in frictional contact with said first side wall and said second and fourth guiding rollers rotate in frictional contact with said second side wall.

11. The system of claim 10, wherein the horizontal spine is coupled to a surface directly below the sliding door so as to place the guiding rollers within the channel of the frame's horizontal bottom portion.

12. The system of claim 10, wherein the guiding roller assembly further includes a mounting bracket that is coupled to the horizontal spine such that, when the bracket is mounted to a wall parallel to the sliding door, the horizontal spine is disposed directly below the door and the guiding rollers are disposed within the channel of the frame's horizontal bottom portion.

13. The system of claim 1, wherein said lower wheel assembly comprises:
a vertical spine having a transverse shaft coupled to a bottom portion thereof, said transverse shaft being disposed perpendicular to the plane of the panel; and
two wheels that are rotatably coupled to said transverse shaft on opposite sides of the vertical spine.

14. The system of claim 13, wherein the two wheels are non-marking sliding wheels.

15. The system of claim 13, said door further including a second lower wheel assembly, wherein the first lower wheel assembly is coupled to the frame's first vertical side portion and the second lower wheel assembly is coupled to the frame's second vertical side portion.

16. The system of claim 15, wherein said door includes a pair of upper roller assemblies disposed proximate opposite ends of the frame's horizontal top portion.

17. The system of claim 1, said frame including a vertical member that is parallel to said first and second vertical side portions, wherein the door includes a first panel encased between the first vertical side portion and the vertical member and a second panel encased between the second vertical side portion and the vertical member.

18. The system of claim 1, further including at least one divider strip that is removably attached to the panel.

19. The system of claim 1, wherein the panel is made of a member selected from the group consisting of clear glass, milky glass, frosted glass, mirror, and combinations thereof.

20. The system of claim 1, wherein said guiding roller assembly is disposed at least partially within a wall cavity so as to allow the sliding door to extend out from, and retract into, said cavity.

21. A sliding door system comprising:
(a) a sliding door having a frame, a first upper roller assembly and a first lower wheel assembly coupled to a first vertical side portion of the frame, and a second upper roller assembly and a second lower wheel assembly coupled to a second vertical side portion of the frame;
(b) an upper track defining a channel and configured to receive respective rollers of said upper roller assemblies; and
(c) a guiding roller assembly having a plurality of guiding rollers, said guiding rollers being disposed horizontally and being received within a channel defined on an underside of the frame.

22. The system of claim 21, wherein each of said first and second lower wheel assemblies includes a pair of wheels that are configured to slide directly on a surface beneath the door without the need for a lower track.

23. The system of claim 22, wherein said surface is a member selected from the group consisting of a non-covered floor, a carpeted floor, a tiled floor, a laminate floor, a marble floor, a wood floor, and a slated floor.

24. The system of claim 22, wherein the guiding roller assembly includes a horizontal spine, said guiding rollers being rotatably mounted on the spine in a staggered configuration such that respective centers of successive rollers are disposed on opposite sides of the spine's longitudinal center line.

25. The system of claim 24, wherein the horizontal spine is coupled to said surface so as to place the guiding rollers within the channel defined in the frame's underside.

26. The system of claim 24, wherein the guiding roller assembly further includes a mounting bracket that is coupled to the horizontal spine such that, when the bracket is mounted to a wall parallel to the sliding door, the horizontal spine is disposed directly below the door and the guiding rollers are disposed within the channel defined in the frame's underside, said horizontal spine making no contact with said surface.
